(19) United States
(12) Patent Application Publication
(10) Pub. No.: US 2010/0058795 A1
(43) Pub. Date: Mar. 11, 2010

(54) Automotive dash board mounted evaporative cooling system

(76) Inventor: Eric Allen Schmitter, Victorville, CA (US)

Correspondence Address: Eric Schmitter, 12800 Triple Tree Terrace, Victorville, CA, 92392, US

(21) Appl. No.: 12/462,178

(22) Filed: Jul. 30, 2009

Related U.S. Application Data
(60) Provisional application No. 61/191,432, filed on Sep. 9, 2008.

(51) Int. Cl. B60H 1/32

(52) U.S. Cl. 62/314

(57) ABSTRACT

An Automotive dash board mounted evaporative cooling system. A small, light weight, portable square housing manufactured from molded plastic. The housing has two air intake doors that open up to a forty-five degree angle. These doors open from the top and have piece of cloth that can be cleaned and reused. There is a fan shroud that is built into the front section of the housing that helps direct the air be pushed out of it. A suction pump is mounted to the back of the housing which pulls water from a separate water bottle through a pair of plastic or vinyl tubing. There is a universal bottle cap that allows the suction pump hoses to fit on any water bottle. The system is powered by a cord that can be plugged into an automotive accessory outlet and or cigarette lighter outlet. It mounts on all dash boards.

Claiming priority from U.S. Provisional Application with Ser. No. 61/191,432, filed on Sep. 9, 2008.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISK APPENDIX

“Not Applicable”

### BACKGROUND OF THE INVENTION

### Field of the Invention

The invention relates to the field of portable evaporative coolers, more specifically, automotive portable evaporative coolers that are compact, easy to install and easy to use.

Most evaporative coolers are big and bulky. They are also heavy and require complex ways of installation. Along with these things, most evaporative cooling systems require that the owner replaces the saturation pads and or filters every year.

There is a need for an evaporative cooling system that is not bulky, heavy, hard to install and one that requires no changing of the saturation pads. There is also a need for an evaporative cooler that is portable for automotive applications.

### BRIEF SUMMARY OF THE INVENTION

The Automotive dash board mounted evaporative cooling system is a small square shaped box. The front of the evaporative cooler is the same size as the rear side. The top and the bottom of the cooler are the same size. The left and right sides are the same size.

The bottom of the evaporative cooler is flat on the outside and angled on the inside. The bottom section is used to drain water out of the box back into the water supply bottle.

The front of the evaporative cooler has an adjustable vent built onto it to direct the cool air coming from inside the evaporative cooler.

The top of the cooler is flat with a power switch mounted into it. The power switch controls the power to the fan motor and to the suction pump.

The left and right sides of the cooler have doors that tilt out forty-five degrees from the top. These doors are vented to allow air into the saturation pads that sit inside the door. The pads are made from a material that can be taken out and cleaned.

The back side of the evaporative cooler has a hole in the center where a mounting bracket can be placed. There is also a few mounting holes where a small suction pump is placed. There are also holes where water is fed.

Inside the cooler box is a bracket that holds the small motor horizontally that turns the fan that pulls air into and pushes air out of the cooler horizontally.

There is a small suction pump that is mounted to the outside of the back of the cooler. It pulls water into the evaporative cooler and pushes extra water back out of the cooler. This pump is motor driven. The pump draws its water through either rubber and or vinyl tubing. This tubing is attached to the section pump and then to a water bottle containing a universal cap that is made from a stretchy material.

### BRIEF DESCRIPTION OF THE SEVERAL VIEWS OF THE DRAWING

FIG. 1 is a “A” front prospective of the automotive dash board mounted evaporative cooling systems main housing and “B” showing the fan blade without the vent attached to the housing.

FIG. 2 is “C” a drawing of the universal water bottle cap that is attached to the hoses feeding the system;

FIG. 3 is a perspective view of the suction pump, “F” showing its small twelve volt direct currant motor, “D” its molded plastic housing, “E” its two nipples that the water hoses connect to and the two mounting holes.

FIG. 4 is a perspective view of the back side of the housing, “G” the center hole where a clip is mounted, “I” two mounting holes for the suction pump and “H” shows the two holes the distribution duct is mounted through.

FIG. 5 is a perspective view of the front of the automotive dash board mounted evaporative cooling system, “K” showing the adjustable vent and “J” showing the side air intake doors that open up to a forty-five degree angle.

FIG. 6 is an open view of the inside of the main housing of the automotive dash board mounted evaporative cooling system, “N” showing the twelve volt direct currant fan motor, “M” shows the water distribution duct, “O” the built in fan shroud and “L” shows the suction pump mounted on the back of the housing.

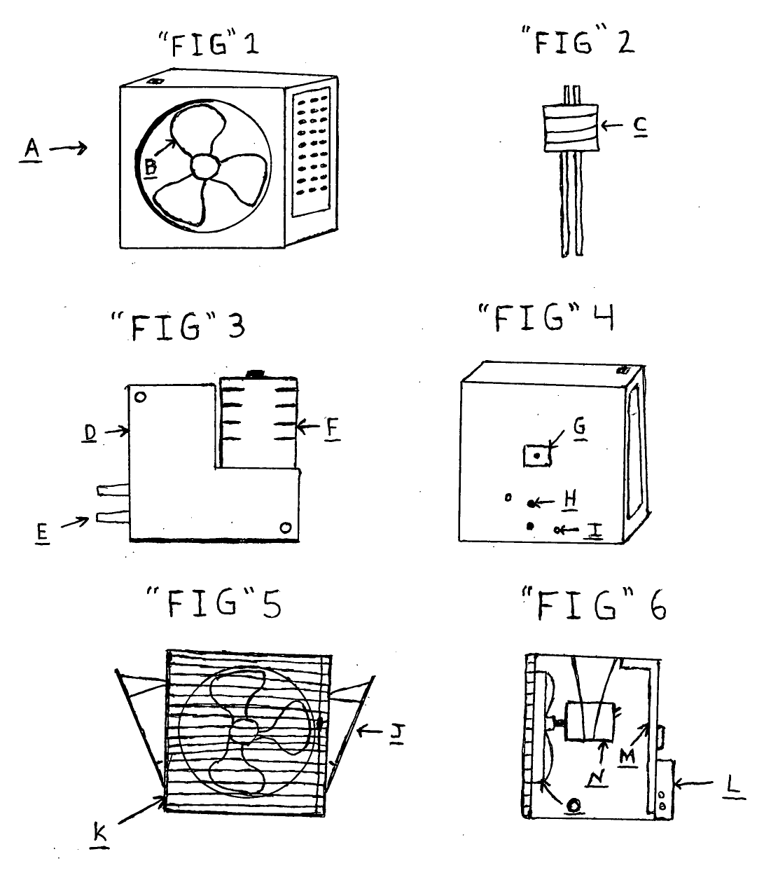

### DETAILED DESCRIPTION OF THE INVENTION

The (Automotive Dash Board Mounted Evaporative Cooling System) is described as follows: a small square and or rectangle box that is approximately four inches long and four inches wide in diameter. It is approximately one and three quarts inches deep. The (Dash Board Mounted Evaporative Cooling System) has a solid bottom and a solid top with no holes. The left and right sides of the (Automotive Dash Board Mounted Evaporative Cooling System) have vented doors that are approximately one and a quarter wide and approximately three inches long. These two side doors open outward at an approximated forty-five degrees. The two doors once opened, contain a piece of cloth that can be removed and cleaned so that it may be placed back into the door and reused. The doors are designed so that if the (Automotive Dash Board Mounted Evaporative Cooling System) gets tilted up to forty-five degrees, the water inside will not spill out of the unit.

The front of the (Automotive Dash Board Mounted Evaporative Cooling System) which is four inches long by four inches wide has a vented facing. The (Automotive Dash Board Mounted Cooling System) has a control switch which is placed in the top of it. The switch has off, low and high positions.

The back of the (Automotive Dash Board Mounted Evaporative Cooling System) is solid except for a set of power wires coming out of it and a place where a small prime pump hooks up. The area in which the prime pump hooks up has two holes that feed water into the (Automotive Dash Board Mounted Evaporative Cooling System). These prime pump holes are connected to a system that feeds water to the pieces of cloth that are located in the two side doors. The power wires going into the back of the unit feed the control switch which feeds the suction pump and fan motor that pulls air in and pushes air out of the (Automotive Dash Board Mounted Evaporative Cooling System).

From the section pump that mounts to the back of the A.D.B.M.E.C.S mounts two small hoses which can be made from rubber and or vinyl. These two hoses vary in length depending upon the application in which the (Automotive Dash Board Mounted Evaporative Cooling System) is being used. The two hoses come out from the section pump and are attached to a rubberized universal cap. This cap being universal is then able to be placed on a number of different types of water bottles. The bottle, full with water, will be able to supply the A.D.B.M.E.C.S with the water it needs to cool with. There will be a plastic refillable bottle that comes with the unit as well as a universal bottle sleeve that will help keep the water in the bottle cool.

The power wires that come out of the back of the (Automotive Dash Board Mounted Evaporative Cooling System) will also range in length dependent upon the application in which the A.D.B.M.E.C.S is being used. These power wires will have a plug on them that will allow them to be plugged into the cars cigarette lighter and or power outlet, a maximum of twelve volts being used.

The (Automotive Dash Board Mounted Evaporative Cooling System) is made from molded plastic. Molds are made for the front section, rear section, side doors, water distribution duct, water retainer, front vent, fan and suction pump. Once the parts are molded the parts are assembled. The color is interchangeable depending on the application in which it is being used. It will also have a place on the back in which a mounting bracket can be installed so that it can be mounted in more than one way. These mounting options include a mounting for an air vent, mounting for clip for the back of a seat, and mounting for the dash board. The size of the (Automotive Dash Board Mounted Evaporative Cooling System) will vary dependent upon its application. Its size will not exceed twelve inches squared.

How It Works: The cooling system is mounted to the dash board or any other optional mounting locations. The hoses that come out of the back of the suction pump go down to a cap that is placed on a bottle of water. This bottle of water can be any temperature but the colder the better. There can be a sleeve put on the bottle in order to keep the temperature of the water as cool as possible. The hoses that are attached to the cap pick up the water from the bottom of the bottle. The power wires are plugged into one of the power outlets in the vehicle. The power switch on the top of the cooling system is switched in the on position. Once the power is on the small fan inside the cooling box will turn on. The speed will vary dependent upon what the switch is placed at. At the same time the fan comes on the small suction pump will come on and start drawing water from the water bottle into the box. The water that enters the box will start to saturate the cloth pads inside of the doors. Once the cool air is pulled into the box, it is then pushed out by the same fan pulling it in. The fan will vary in pitch so that maximum air is used. The air is pulled into and pushed out of the cooling box and the air in the car will cool down because of increased moisture in the air. Only the air in the car is to be used. This system is to work well only if the outside air is off and the windows are closed.

I claim:

1. An Automotive dash board mounted evaporative cooling system comprising: a. A small, light weight, portable, square housing, said square housing further having a front, a rear, a top, a bottom, two sides and a median portion there between, said bottom side including a water drain area and a water retainer sleeve, said top side having a power switch for turning the system on and off, said front side having a circle shaped hole in it where a fan shroud is molded around it's inside, said front side being the air exhaust vent of the system, said front side having an adjustable vent that is attached to it, said rear side having a suction pump that is mounted to it, said side walls having an air intake door that opens to a forty-five degree angle, and said median portion contains the inner workings; b. a fan assembly including a built in fan shroud, a fan motor, a water distribution duct and electrical wiring.

2. An Automotive dash board mounted evaporative cooling system as in claim 1 in which said light weight square housing weighs less than seven pounds.

3. An Automotive dash board mounted evaporative cooling system as in claim 1 in which said small square housing is no larger than twelve inches squared.

4. An Automotive dash board mounted evaporative cooling system as in claim 1 in which said housing is manufactured from molded plastic.

5. An Automotive dash board mounted evaporative cooling system as in claim 1 in which said water retainer sleeve is “M” shaped.

6. An Automotive dash board mounted evaporative cooling system as in claim 1 in which said air intake doors open from the top and hinge on the bottom at a forty-five degree angle.

7. An Automotive dash board mounted evaporative cooling system as in claim 6 is also said to contain a built in shelve in which an air permeable water element is placed.

8. An Automotive dash board mounted evaporative cooling system as in claim 6 in which said air permeable water element is said to be cleanable and able to be reused.

9. An Automotive dash board mounted evaporative cooling system as in claim 1 in which said power switch is a multiple speed switch.

10. An Automotive dash board mounted evaporative cooling system as in claim 1 in which said fan motor is mounted horizontally.

11. An Automotive dash board mounted evaporative cooling system as in claim 10 is said to operate on twelve volts direct currant.

12. An Automotive dash board mounted evaporative cooling system as in claim 1 in which said water distribution duct attaches to the inside back wall.

13. An Automotive dash board mounted evaporative cooling system as in claim 1 in which said water distribution duct is manufactured from molded plastic.

14. An Automotive dash board mounted evaporative cooling system as in claim 1 in which said suction pump is manufactured from molded plastic.

15. An Automotive dash board mounted evaporative cooling system as in claim 14 is said be driven by a small direct currant motor.

16. An Automotive dash board mounted evaporative cooling system as in claim 15 in which said motor uses no more than twelve volts direct currant.

17. An Automotive dash board mounted evaporative cooling system as in claim 1 in which said suction pump is fed water by two small water hoses.

18. An Automotive dash board mounted evaporative cooling system as in claim 17 in which said hoses are attached from the suction pump to a small water bottle.

19. An Automotive dash board mounted evaporative cooling system as in claim 18 in which said hoses are attached to the water bottle by a universal bottle cap manufactured from a stretchy material.

20. An Automotive dash board mounted evaporative cooling system as in claim 1 further having an electrical plug that is plugged into any automotive accessory outlet and or an automotive cigarette lighter outlet.

21. An Automotive dash board mounted evaporative cooling system as in claim 1 which said portable, light weight, square housing mounts on the top of an automotive dash board and or the back of an automotive seat.

22. An Automotive dash board mounted evaporative cooling system as in claim 1 which said portable, light weight, square housing also mounts by a clip on the back to an air conditioning vent on any automotive application.
